(19) United States
(12) Patent Application Publication
(10) Pub. No.: US 2004/0170329 A1
(43) Pub. Date: Sep. 2, 2004

(54) Image processing apparatus, image data processing method, and recording medium

(76) Inventors: Takahiro Yagishita, Kanagawa (JP); Yukiko Yamazaki, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/731,146

(22) Filed: Dec. 10, 2003

(30) Foreign Application Priority Data
Dec. 10, 2002 (JP) 2002-358430

(51) Int. Cl. G06K 9/36

(52) U.S. Cl. 382/232

(57) ABSTRACT

An image processing system includes a transmission-side apparatus that transmits image data and a reception-side apparatus that receives and visualizes the image data. In the transmission-side apparatus, a data generator generates an image data, a first converter subjects the image data to a first conversion to thereby generate a first image data, a second converter subjects the first image data to a second conversion to thereby generate a second image data, a subtractor subtracts the second image data from the image data to thereby generate a third image data, a compressor compresses the third image data to thereby generate compressed image data, and an embedding unit embeds the compressed image data in the first image data.

### CROSS-REFERENCE TO RELATED APPLICATIONS

The present document incorporates by reference the entire contents of Japanese priority document, 2002-358430 filed in Japan on Dec. 10, 2002.

### BACKGROUND OF THE INVENTION

1) Field of the Invention

The present invention relates to an image processing system including a transmission-side image processing apparatus that embeds information having been deleted from image data in the image data and outputs the image data in a standard format, and reception-side image processing apparatuses as primary and secondary targets that restore the image data based on the information extracted from the input standard format image data.

2) Description of the Related Art

In an image processing system including a transmission-side image processing apparatus that reads a paper document by a scanner and transmits electronic image data and a reception-side image processing apparatus that receives and visualizes the transmitted image data, it is generally known that the reception-side image processing apparatus includes a reception-side image processing apparatus as a primary target and a reception-side image processing apparatus as a secondary target. It is assumed here that the reception-side image processing apparatus of the system is a display device if used as the primary target (main target), and is a printer if used as the secondary target (auxiliary target). The transmission-side apparatus converts basic specification (resolution, number of colors, or sampling frequency) of image data obtained by scanning so as to match with equipment such as a monitor used for the primary target, and transmits converted data. In this case, the conversion is performed so as to reduce mainly the value of the specification.

The value of basic specification of an image required to be displayed with appropriate quality in the reception-side apparatus is different depending on the equipment. As for resolution, the printer generally requires a larger specification value than the monitor. Assume the case where the reception-side apparatus as the secondary target requires a larger specification value than that of the reception-side apparatus as the primary target, if the transmission-side apparatus reduces the specification value so as to match with the apparatus as the primary target, the image quality cannot be ensured in the apparatus as the secondary target. This is because image data cannot be restored to high quality image data with the large specification value again from the image data whose specification value has been reduced. In other words, the deleted information cannot be restored again.

However, even in the above case, there are two image data converting methods capable of ensuring image quality in the image processing apparatus as the secondary target.

One of the methods is to convert basic specification so as to match with the image processing apparatus as the secondary target (first conventional method). The other method is to convert basic specification into two files of image data that is converted so as to match with the image processing apparatus as the primary target and of information data that is deleted through the conversion, and restoring image data with high image quality from both of the data (second conventional method).

However, the first conventional method has a defect such that the equipment as the primary target has to convert the basic specification of the image data. The second conventional method has a defect such that the two files make the operation complicated.

A method similar to the above methods is disclosed in Japanese Patent Application Laid Open No. 2001-127985. According to this method disclosed in this publication, a transmission-side image processing apparatus embeds histogram of information for an electronic watermark in image data, and a reception-side image processing apparatus extracts the histogram and subjects it to color process based on the information to obtain an image with high quality. The object of this method is to take the load of generating the histogram off the reception side by putting the load only on the transmission side. However, in this method, although the file is made to one, the image quality cannot be ensured in the equipment as the secondary target, only because information is embedded in image data in such a manner that the information can also be generated from the received image data (identical information is doubly included).

### SUMMARY OF THE INVENTION

It is an object of the present invention to solve at least the problems in the conventional technology.

An image processing apparatus according to an aspect of the present invention includes a first converter that subjects an image data to a first conversion to thereby generate a first image data; a second converter that subjects the first image data to a second conversion to thereby generate a second image data; an arithmetic unit that conducts an arithmetic operation on the image data and the second image data to thereby generate a third image data; a compressor that compresses the third image data to thereby generate a compressed image data; and an embedding unit that embeds the compressed image data in the first image data.

An image processing apparatus according to another aspect of the present invention includes a converter that subjects an image data to a predetermined conversion to thereby generate a converted image data; an extractor that extracts embedded data, from the image data, that is data embedded in the image data; a decompressor that decompresses the embedded data extracted to thereby generate a compressed embedded data; and an arithmetic unit that conducts an arithmetic operation on the converted image data the compressed embedded data.

A method of processing image data according to still another aspect of the present invention is carried out by an image processing apparatus that transmits the image data processed to other apparatus. The method includes generating an image data; subjecting the image data to a first conversion to thereby generate a first image data; subjecting the first image data to a second conversion to thereby generate a second image data; conducting an arithmetic operation on the image data and the second image data to thereby generate a third image data; compressing the third image data to thereby generate a compressed image data; and embedding the compressed image data in the first image data.

A method of processing image data according to still another aspect of the present invention is carried out by an image processing apparatus that receives the image data from other apparatus. The method includes subjecting the image data received to a predetermined conversion to thereby generate a converted image data; extracting embedded data, from the image data, that is data embedded in the image data; decompressing the embedded data extracted to thereby generate a compressed embedded data; conducting an arithmetic operation on the converted image data the compressed embedded data to thereby generate an arithmetic data; and visualizing the arithmetic data.

Computer-readable recording medium according to still another aspect of the present invention stores a computer program that makes a computer realizes the methods according to the present invention on a computer.

The other objects, features and advantages of the present invention are specifically set forth in or will become apparent from the following detailed descriptions of the invention when read in conjunction with the accompanying drawings.

### BRIEF DESCRIPTION OF THE DRAWINGS

FIG. 1 is a general view of an image processing system according to an embodiment of the present invention;

FIG. 2A is a block diagram of a transmission-side image processing apparatus according to the embodiment;

FIG. 2B is a block diagram of a reception-side image processing apparatus as a primary target according to the embodiment;

FIG. 2C is a block diagram of a reception-side image processing apparatus, as a secondary target, according to the embodiment;

FIG. 3A to FIG. 3M are diagrams for explaining specific examples of conversions in first, second, and third converters as shown in FIG. 2A and FIG. 2C; and

FIG. 4 is a block diagram of a modification of the reception-side image processing apparatus as the secondary target.

### DETAILED DESCRIPTION

Exemplary embodiments of the present invention are explained in detail below with reference to the accompanying drawings.

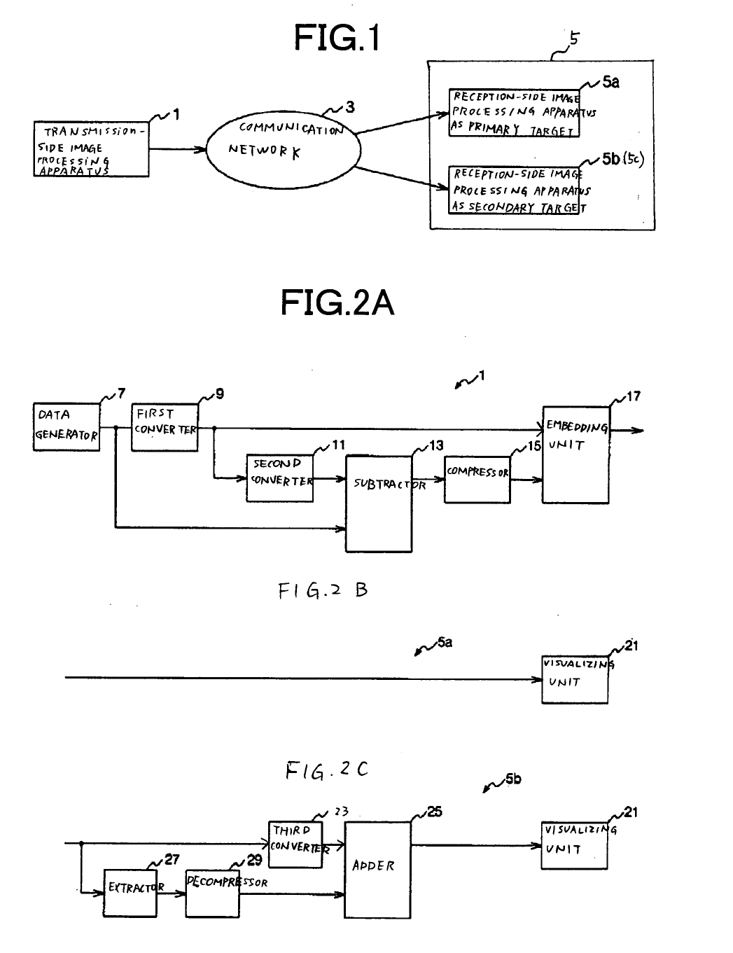

FIG. 1 is a general view of an image processing system according to an embodiment of the present invention.

The image processing system includes a transmission-side image processing apparatus (hereinafter, “transmission-side apparatus”) 1 that transmits read-in image data, and a reception-side image processing apparatus 5 that receives the image data via a communication network 3 and visualizes the image data. The reception-side image processing apparatus 5 includes a reception-side image processing apparatus (hereinafter, “primary reception-side apparatus”) 5a as a primary target and a reception-side image processing apparatus (hereinafter, “secondary reception-side apparatus”) 5b as a secondary target.

FIG. 2A is a block diagram of the transmission-side apparatus 1, FIG. 2B is a block diagram of the primary reception-side apparatus 5a, and FIG. 2C is a block diagram of the secondary reception-side apparatus 5b.

As shown in FIG. 2A, the transmission-side apparatus 1 includes a data generator 7 that generates digital image data, a first converter 9 connected to the data generator 7, a second converter 11 connected to the first converter 9, a subtractor 13 connected to the data generator 7 and the second converter 11, a compressor 15 connected to the subtractor 13, and an embedding unit 17 connected to the first converter 9 and the compressor 15.

The data generator 7 includes a scanner that scans a document such as a printed matter or a photograph paper, a digital still camera/video camera that photographs space, an X-ray camera, a magnetic resonance imaging (MRI) device, a computerized tomography (CT) scanner, or application software for a raster image processor (RIP)/word processor that artificially generates an image.

The first converter 9 and the second converter 11 convert basic specification of the image data. Here, the basic specification indicates resolution, the number of colors, or a sampling frequency. The first converter 9 performs conversion so that values of the specifications are reduced (reduction in the resolution, reduction in the number of colors, and reduction in the sampling frequency). On the other hand, the second converter 11 performs conversion so that the values of the specifications are increased (increase in the resolution, increase in the number of colors, and increase in the sampling frequency).

The process of reducing the resolution indicates the process of widening a spatial quantization width, and the process of increasing the resolution indicates the process of narrowing the spatial quantization width. The process of reducing the number of colors indicates the process of widening a color spatial quantization width, and the process of increasing the number of colors indicates the process of narrowing the color spatial quantization width. The process of reducing the sampling frequency indicates the process of widening a time quantization width, and the process of increasing the sampling frequency indicates the process of narrowing the time quantization width.

The respective conversions are performed by using known image processing methods. For example, a simple sampling method and an averaging method are used for conversion of the resolution to lower one. A nearest neighbor method and a load average interpolation method are used for conversion of the resolution to higher one.

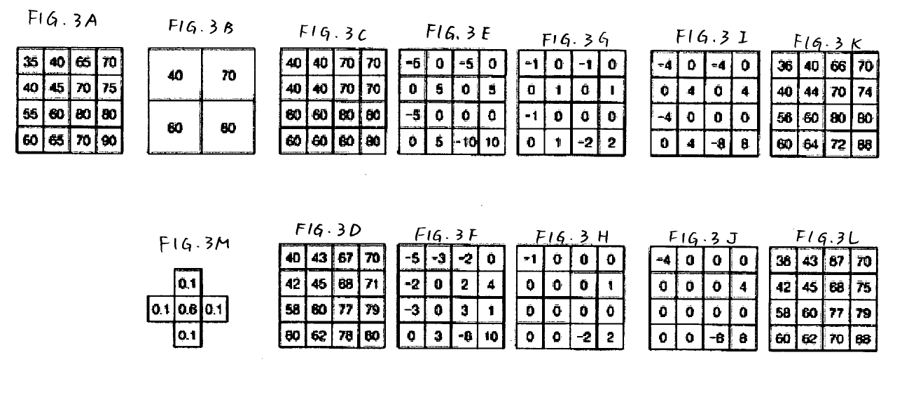

FIG. 3A to FIG. 3M represent specific examples of conversion in the first converter 9 and the second converter 11. FIG. 3A represents a part of the image data, in which one square represents one pixel and a numeral in the square represents a pixel value (gradation), and 4×4 pixels are shown in this example. FIG. 3B represents an image converted to a low-resolution image by using the averaging method. FIG. 3C and FIG. 3D represent images converted to high-resolution images, in which the conversion in FIG. 3C is performed by the nearest neighbor method, and the conversion in FIG. 3D is performed by the load average interpolation method (a load matrix is indicated in FIG. 3M). Although the images in FIG. 3C and FIG. 3D are similar to that of FIG. 3A, they are not perfectly the same as each other. This indicates the example where image data cannot perfectly be restored to the image data with original resolution again from the image data whose resolution has been once reduced. In other words, during the process of reducing the resolution, a part of the information has been deleted, and therefore, it is impossible to restore the deleted information once again.

The example of resolution that is divided by 2 and multiplied by 2 is explained here. However, the present invention is not limited to this example. For example, when 300 dpi-image data is generated in the data generator 7 and the data is transmitted to a 75-dpi monitor as the primary target and to a 150-dpi printer as the secondary target, the resolution is divided by 4 and is multiplied by 2. Further, the resolution is not limited to a second-dimensional resolution, but may be a three-dimensional resolution.

The subtractor 13 obtains a difference between two types of image data. In the examples of FIG. 3A to FIG. 3M, Fig. subtraction is expressed in 3A−FIG. 3C=FIG. 3E and FIG. 3A−FIG. 3D=FIG. 3F.

The compressor 15 performs entropy encoding after quantization. FIG. 3G and FIG. 3H are results of quantizing FIG. 3E and FIG. 3F, respectively (that is, FIG. 3E and FIG. 3F are divided by 4, and each of the remainders is rounded down). The entropy encoding is data compression such as arithmetic encoding, Huffman encoding, and universal encoding.

The embedding unit 17 replaces a redundant part of the image data with embedded data using an electronic watermark technology. The electronic watermark technology is a process of altering image data based on the embedded information within a range in which degradation of the image quality is not noticeable. This technology has been a notable technology in recent years that is applied to embedding information such as copy right in a contents image.

The operation of the transmission-side apparatus 1 is explained below with reference to FIG. 2A.

The image data (FIG. 3A) generated in the data generator 7 is subjected to lower resolution (FIG. 3B) in the first converter 9, and information to be embedded explained later is embedded in the image data by the embedding unit 17. Thereafter, the embedded information is converted to the standard format by the standard format converter (not shown) and the converted information is transmitted to the reception-side image processing apparatus 5. As the information to be embedded, data obtained by compressing differences (FIG. 3E and FIG. 3F) in the compressor 15 is used. The differences are between data whose resolution is reduced in the first converter 9 and increased in the second converter 11 (FIG. 3C and FIG. 3D) and the data (FIG. 3A) before the resolution is reduced.

Conversion of the embedded information to the standard format allows transmitted or received image data to be generalized, which makes it possible to ensure use of the data in the reception-side image processing apparatus. The standard format includes JPEG (Joint Photographic Experts Group), JEPG 2000, MPEG (Moving Pictures Experts group) 2, and MPEG 4 as the international standard. As the information is embedded in the image data, it is not complicated to handle a file as compared to the second conventional method in which the embedded information is handled as a separate file.

In the examples of FIG. 3A to FIG. 3M, the entropy, in the case of handling 16 quantized values as non-stored information source, is 1.91 bit/pixel in FIG. 3G and 1.31 bit/pixel in FIG. 3H. Further, if the quantized values are handled based on Markov model, the entropy is further smaller. If the entropy is 1 bit/pixel, then information of 4 bit/pixel is embedded in the low resolution image of FIG. 3B. If the gradation (number of colors) is 24 bit/pixel and the redundancy of the image data related to image quality is originally 4/24=16%, this part can be replaced with the embedded information without degradation of the image quality.

FIG. 2B is a block diagram of the primary reception-side apparatus 5a.

As shown in FIG. 2B, the primary reception-side apparatus 5a as the primary target includes a visualizing unit 21. In other words, as image data matching with specifications of equipment as a primary target is received, the equipment does not particularly need to convert the image data, and visualizes the data as it is. The processing load of the equipment as a main target is reduced as compared to the first conventional method. If information is embedded within the redundancy range related to the image quality in the equipment as the main target, the image quality can be sufficiently ensured in the equipment as the main target.

The visualizing unit 21 visualizes digital image data, and is a display unit such as a monitor, projector, and printer.

FIG. 2C is a block diagram of the secondary reception-side apparatus 5b.

The secondary reception-side apparatus 5b includes a third converter 23 that receives image data from the transmission-side apparatus 1 and converts the basic specification of the data, and an adder 25 connected to the third converter 23. The secondary reception-side apparatus 5b also includes an extractor 27 that receives the image data from the transmission-side apparatus 1 and extracts embedded data, a decompressor 29 connected to the extractor 27 and the adder 25, and a visualizing unit 21 connected to the adder 25.

The third converter 23 largely converts resolution as the basic specifications of the image data transmitted from the transmission-side apparatus 1.

The extractor 27 extracts the embedded data from the image data using the electronic watermark technology.

The decompressor 29 performs entropy decoding on the image data and then performs reverse quantization thereon. The images of FIG. 3G and FIG. 3H subjected to reverse quantization (×4) are represented by the images of FIG. 3I and FIG. 3J.

The adder 25 obtains a sum of two types of image data. Addition is expressed in FIG. 3C+3I=FIG. 3K and FIG. 3D+FIG. 3J=FIG. 3L.

The visualizing unit 21 visualizes the digital image data, and is a display unit such as a monitor, projector, and a printer.

The operation of the secondary reception-side apparatus 5b (FIG. 2C) is explained below.

The third converter 23 subjects the image data transmitted from the transmission-side apparatus 1 through the communication network 3 to high resolution in order to match with the specifications of the secondary reception-side apparatus 5b, and obtains high resolution data (FIG. 3C and FIG. 3D). The extractor 27 extracts the embedded data from the image data transmitted from the transmission-side apparatus 1. The decompressor 29 conducts entropy decoding on the embedded data (FIG. 3G and FIG. 3H) and conducts reverse quantization thereon to obtain reversely quantized data (3I and FIG. 3J). The adder 25 adds the high resolution data (FIG. 3C and FIG. 3D) and the reversely quantized data (3I and FIG. 3J) to each other to obtain data (FIG. 3K and FIG. 3L), and the data is displayed on the visualizing unit 21.

A difference (average of absolute values of differences between pixel values) from the original image (FIG. 3A) is 3.13 in FIG. 3C and 2.88 in FIG. 3D before the addition, whereas the difference becomes smaller after the addition such as 0.63 in FIG. 3K and 1.38 in FIG. 3L. These figures mean that the addition allows high quality images.

In other words, a part of the information that has been deleted in the transmission-side apparatus to obtain low resolution information is embedded in the image data in a range in which the embedded information does not affect the equipment as the main target. The embedded information is extracted and used in the equipment as the auxiliary target, and thereby sufficient image quality can be ensured in the equipment as the auxiliary target.

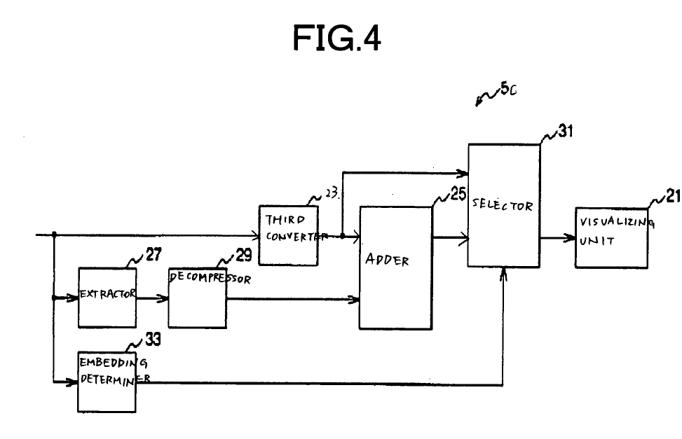

FIG. 4 is a block diagram of a modification of the secondary reception-side apparatus 5c.

The secondary reception-side apparatus 5c includes the third converter 23 that receives the image data from the transmission-side apparatus 1 and converts the basic specification of the data, and the adder 25 connected to the third converter 23. The reception-side apparatus 5c also includes the extractor 27 that receives the image data from the transmission-side apparatus 1 and extracts embedded information from the image data, the decompressor 29 connected to the extractor 27 and the adder 25, and a selector 31 connected to the adder 25. The reception-side apparatus 5c further includes the visualizing unit 21 connected to the selector 31, and an embedding determiner 33 that receives the image data from the transmission-side apparatus 1 to determine whether any information is embedded in the image data, and transmits the result of determination to the selector 31.

That is, in the secondary reception-side apparatus 5c, the embedding determiner 33 is added to the secondary reception-side apparatus 5b of FIG. 2C. The selector 31 selects a process so as to perform addition if it is determined by the embedding determiner 33 that the information is embedded, and selects another process so as not to perform the addition if it is determined that the information is not embedded. In such a configuration, the secondary reception-side apparatus 5c can receive image data also from any device other than the transmission-side apparatus 1 of FIG. 2A, which allows the reception-side equipment to be more versatile.

The embedding determiner 33 determines whether embedded data such as an electronic watermark is included in the image data, and generally determines on it depending on whether predetermined pattern data can be detected as embedded data.

Thus, according to the embodiment, the resolution is converted in the first, second, and third converters 9, 11, and 23, but the number of colors and sampling frequency may be converted in the converters 9, 11, and 23. In this case, the substantially same effect as the examples of resolutions can be obtained in terms of the principle of the operation although a space to be quantized is different.

The respective units of the transmission-side apparatus 1 and the reception-side apparatuses of FIG. 2A to FIG. 2C are illustrated as the functional blocks, but the functions may be realized by a computer or by reading a computer program stored in a recording medium.

According to one aspect of the present invention, it is possible to reduce the processing load, ensure sufficient image quality, ensure the use of the image data in the reception-side apparatus, and also make the reception-side apparatus more versatile.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. An image processing apparatus, comprising:
a first converter that subjects an image data to a first conversion to thereby generate a first image data;
a second converter that subjects the first image data to a second conversion to thereby generate a second image data;
an arithmetic unit that conducts an arithmetic operation on the image data and the second image data to thereby generate a third image data;
a compressor that compresses the third image data to thereby generate a compressed image data; and
an embedding unit that embeds the compressed image data in the first image data.

2. The image processing apparatus according to claim 1, wherein the first conversion includes widening a spatial quantization width, and the second conversion includes narrowing the spatial quantization width.

3. The image processing apparatus according to claim 1, wherein the first conversion includes widening a color spatial quantization width, and the second conversion includes narrowing the color spatial quantization width.

4. The image processing apparatus according to claim 1, wherein the first conversion includes widening a time quantization width, and the second conversion includes narrowing the time quantization width.

5. The image processing apparatus according to claim 1, wherein the embedding unit embeds the compressed image data in the image data using electronic watermark technology.

6. The image processing apparatus according to claim 1, further comprising an outputting unit that outputs, as an image file in a predetermined format, the first image data in which the embedding unit has embedded the compressed image data.

7. The image processing apparatus according to claim 1, wherein the arithmetic operation includes subtracting the second image data from the image data.

8. An image processing apparatus, comprising:
a converter that subjects an image data to a predetermined conversion to thereby generate a converted image data;
an extractor that extracts embedded data, from the image data, that is data embedded in the image data;
a decompressor that decompresses the embedded data extracted to thereby generate a compressed embedded data; and
an arithmetic unit that conducts an arithmetic operation on the converted image data the compressed embedded data.

9. The image processing apparatus according to claim 8, wherein the extractor extracts embedded data from the image data using electronic watermark technology.

10. The image processing apparatus according to claim 8, further comprising a receiving unit that receives the image data as an image file in a predetermined format.

11. The image processing apparatus according to claim 8, further comprising:
a embedding determiner that determines whether embedded data has been embedded in the image data; and
a selector that receives the converted image data, the compressed embedded data, and result of determination from the embedding determiner, outputs the converted image data when the result of determination indicates that embedded data has been embedded in the image data and outputs the compressed embedded data when the result of determination indicates that embedded data has not been embedded in the image data.

12. The image processing apparatus according to claim 8, wherein the arithmetic operation includes adding the converted image data and the compressed embedded data.

13. A method of processing image data, the method being carried out by an image processing apparatus that transmits the image data processed to other apparatus, comprising:
generating an image data;
subjecting the image data to a first conversion to thereby generate a first image data;
subjecting the first image data to a second conversion to thereby generate a second image data;
conducting an arithmetic operation on the image data and the second image data to thereby generate a third image data;
compressing the third image data to thereby generate a compressed image data; and
embedding the compressed image data in the first image data.

14. A method of processing image data, the method being carried out by an image processing apparatus that receives the image data from other apparatus, comprising:
subjecting the image data received to a predetermined conversion to thereby generate a converted image data;
extracting embedded data, from the image data, that is data embedded in the image data;
decompressing the embedded data extracted to thereby generate a compressed embedded data;
conducting an arithmetic operation on the converted image data the compressed embedded data to thereby generate an arithmetic data; and
visualizing the arithmetic data.

15. A computer-readable recording medium that records a computer program that makes a computer process an image data and transmit the image data processed to other apparatus, the computer program making the computer execute:
generating an image data;
subjecting the image data to a first conversion to thereby generate a first image data;
subjecting the first image data to a second conversion to thereby generate a second image data;
conducting an arithmetic operation on the image data and the second image data to thereby generate a third image data;
compressing the third image data to thereby generate a compressed image data; and
embedding the compressed image data in the first image data.

16. A computer-readable recording medium that records a computer program that makes a computer receive an image data from other apparatus and process the image data, the computer program making the computer execute:
subjecting the image data received to a predetermined conversion to thereby generate a converted image data;
extracting embedded data, from the image data, that is data embedded in the image data;
decompressing the embedded data extracted to thereby generate a compressed embedded data;
conducting an arithmetic operation on the converted image data the compressed embedded data to thereby generate an arithmetic data; and
visualizing the arithmetic data.
